(19) United States
(12) Patent Application Publication
(10) Pub. No.: US 2014/0289706 A1
(43) Pub. Date: Sep. 25, 2014

(54) TEST CASE GENERATION METHOD, TEST CASE GENERATION DEVICE, AND STORAGE MEDIUM

(71) Applicant: Hitachi, Ltd., Tokyo (JP)

(72) Inventors: KUNIHIKO MIYAZAKI, Tokyo (JP); Naoto SATO, Tokyo (JP); Shinji ITOH, Tokyo (JP); Sadahiro ISHIKAWA, Tokyo (JP); Kiyoshi YAMAGUCHI, Tokyo (JP); Hiroki MORI, Tokyo (JP)

(73) Assignee: Hitachi, Ltd., Tokyo (JP)

(21) Appl. No.: 14/171,163

(22) Filed: Feb. 3, 2014

(30) Foreign Application Priority Data
Mar. 22, 2013 (JP) 2013-059281

(51) Int. Cl. G06F 11/36

(52) U.S. Cl. CPC G06F 11/3684
USPC 717/124

(57) ABSTRACT

A test case is generated by receiving software specification, generating a test case including a test input value for particular software from the software specification, as well as an expected output value expected to be obtained as an output value when the software is executed by inputting the test input value, and checking whether a value that can be output in the software specification is included in the expected output value. As a result of the check, if it is determined that the output value that can be output in the software specification is not included in the expected output value, a test case including the value that can be output in the software specification as well as a corresponding test input value is generated and added to the test case that has been generated.

### CROSS-REFERENCE TO RELATED APPLICATIONS

The present application claims the benefit of priority to Japanese Patent Application No. 2013-059281, filed Mar. 22, 2013, of which full contents are incorporated herein by reference.

### BACKGROUND OF THE INVENTION

The present invention relates to a technology for supporting software development, and more particularly, to a technology for generating a test case from a specification.

The specification of software may be defined by the relationship between the condition before the execution of the software and the result after the execution of the software. This specification is defined as the function when seen from the outside of the software, so that it may be referred to as external specification or functional specification. It is known that the relationship between the condition and the result can be expressed in the form of a table, called a decision table, as the expression method of the external specification. The decision table is frequently used in the software development process.

Further, the software test method is known as the method for checking whether the developed software behaves as specified in the external specification. The software test may be performed using a test case as a unit. Here, the test case is the data including a test input value (test input data) which is the input value (input data) for particular software, and an expected output value (expected output data) which is the output value expected to be obtained as the output value when the software is executed by inputting the particular test input value. When the software is actually executed with the test input value and if the expected output value can be obtained as the output value, the test is passed for the particular test case.

From the point of view of checking the relationship with the specification more properly, it is desirable to test the software for as many test cases as possible. For example, if test cases for all possible inputs allowed in the specification are executed and passed, the fact that the particular software behaves as specified in the specification is checked for all the values.

However, for example, if the input is expressed as a combination of multiple factors, the size of the range of values that can be taken as the input is the product of the number of values that the individual factors can take (which are referred to as level values). Thus, the size of the range of possible values of the input is very large. In such a case, the test for all the test cases is not completed in realistic time, which makes it difficult to be performed.

In this case, the pairwise method (also referred to as the all-pair method) (A. Blass and Y. Gurevich, “Pairwise Testing”, Bulletin of the European Association for Theoretical Computer Science Number 78, October 2002, 100-132.) is known as the method for extracting a realistic number of test cases that can be executed. This method is developed to significantly reduce the number of test cases on the basis of the theory of n-factor coverage that when the input is expressed as a combination of multiple factors, many defects are caused by the combination of n factors (where n is a relatively small number).

### SUMMARY OF THE INVENTION

According to the technology disclosed in the related literature, even if the size of the range of all the inputs that can be taken from the specification of the software to be tested is very large, it is possible to extract a realistic number of test cases that can be executed. However, the extraction is based on the factor of the input, and there is no particular consideration of the output. In other words, the distribution of the test input value of a test case is considered to a certain extent, but there is no consideration of the expected output value corresponding to the input value.

Thus, it cannot be denied that the distribution of the expected output value included in the test case extracted based on the technology disclosed in the related literature may deviate in the range of values that the software to be tested can output in the specification. For example, if all the expected output values included in the extracted test cases are the same, even if a defect involved in the process of outputting a value different from the particular expected output value is included in the software to be tested, the defect may not be detected. In this case, in the test case generation from the software specification, the process generates a test case that covers only a part of the range of result values that can be output in the specification.

An object of the present invention is to provide a test case generation method for generating a test case covering all possible values that can be output in the software specification, a test case generation device for performing the test case generation method, and a storage medium.

A typical example of the present invention to achieve the above object is as follows. The present invention is a test case generation method in a test case generation device for generating a test case from software specification. The test case generation device performs the steps of: receiving the software specification and storing it in a storage part; generating a test case including a test input value for particular software from the software specification, as well as an expected output value expected to be obtained as an output value when the software is executed by inputting the test input value, and storing the generated test case in the storage part; checking whether a value that can be output in the software specification is included in the expected output value; and as a result of the check, when it is determined that the value that can be output in the software specification is not included in the expected output value, generating a test case including the value that can be output in the software specification as well as a corresponding test input value, and adding the generated test case to the test case stored in the storage part.

According to the present invention, it is possible to generate a test case covering all possible values that can be output in the software specification.

### BRIEF DESCRIPTION OF THE DRAWINGS

FIG. 1 is a block diagram of an example of the hardware and software configuration of a test case generation device 101 according to a first embodiment;

FIG. 2 is a view of an example of a software specification 131 according to the first embodiment;

FIG. 3 is a flow chart showing the outline of the process for generating a test case from the software specification according to the first embodiment;

FIG. 4 is a view of an example of the combination of values providing two-factor coverage, which are selected by the pairwise method according to the first embodiment;

FIG. 5 is a flow chart showing the details of the expected output check process (step 304 in FIG. 3) and the test case addition process (step 305 in FIG. 3) according to the first embodiment;

FIG. 6 is a view of an example of the test cases generated by the process shown in FIGS. 3 and 5 according to the first embodiment; and

FIG. 7 is a flow chart showing the details of the expected output check process and the test case addition process according to a second embodiment.

### DESCRIPTION OF THE PREFERRED EMBODIMENTS

Hereinafter, preferred embodiments of the present invention will be described in detail with reference to the accompanying drawings.

### First Embodiment

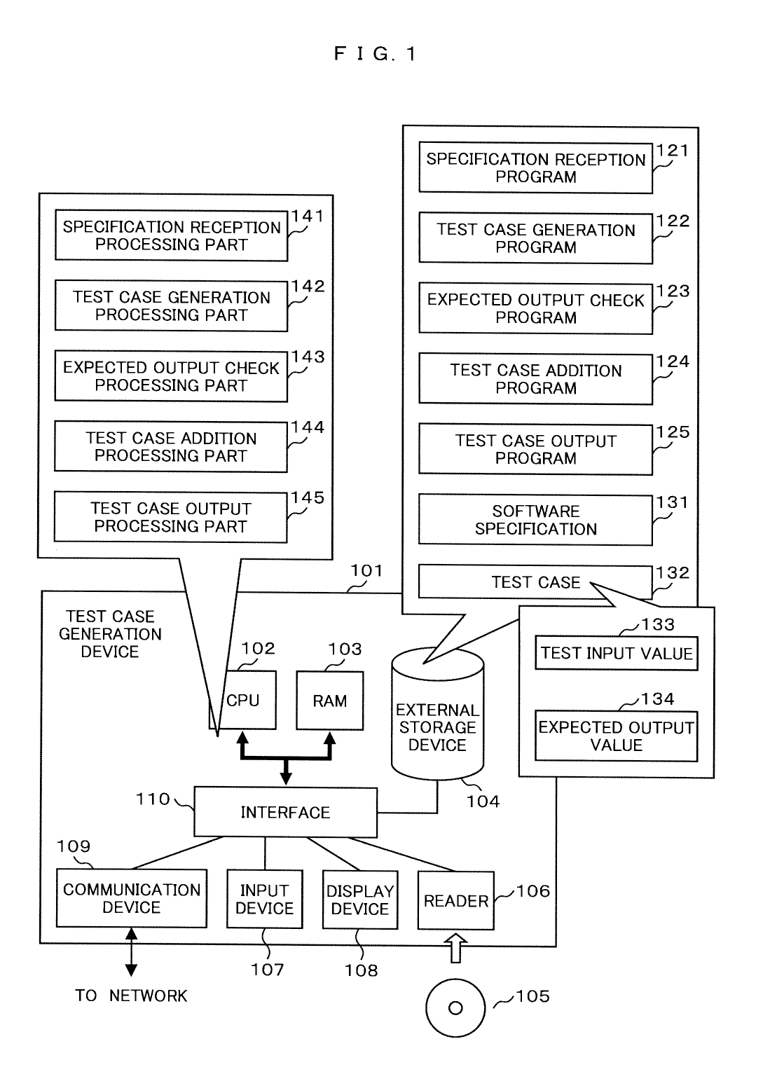

FIG. 1 is block diagram of an example of the hardware and software configuration of a test case generation device 101 according to a first embodiment.

The test case generation device 101 can be configured by a common computer including: a central control device (control part) 102 such as a CPU; a main storage device (storage part) 103 that functions as a working area of the central control device 102, such as RAM; an external storage device (storage part) 104 such as a hard disk device; a reader 106 for reading data from a portable storage medium 105 such as CD-ROM and FD; an input device 107 such as a keyboard and a mouse; a display device 108 such as a display; a communication device 109 for communicating with other devices through a network; and an external interface 110 for data transmission and reception between each of the devices. Note that if the operation of the test case generation device 101 is typically performed through the network, the display device 108 and the input device 107 may not be connected to the test case generation device 101.

The external storage device 104 of the test case generation device 101 stores a specification reception program 121, a test case generation program 122, an expected output check program 123, a test case addition program 124, and a test case output program 125. These programs are loaded on the main storage device 103 and are embodied by the central control device 102 as a function of a specification reception processing part 141, a test case generation processing part 142, an expected output check processing part 143, a test case addition processing part 144, and a test case output processing part 145. Each of the programs for realizing the processing parts may be stored in the external storage device 104 in advance, or may be stored in the storage medium 105 and read through the reader 106 according to need. Alternately, each program may be downloaded from another device connected to the communication device 109 using a network or carrier, which is a communication medium that the computer can use, according to need, and stored in the external storage device 104.

Further, the external storage device 104 stores the software specification 131 and a test case 132. The test case includes a test input value 133 and an expected output value 134.

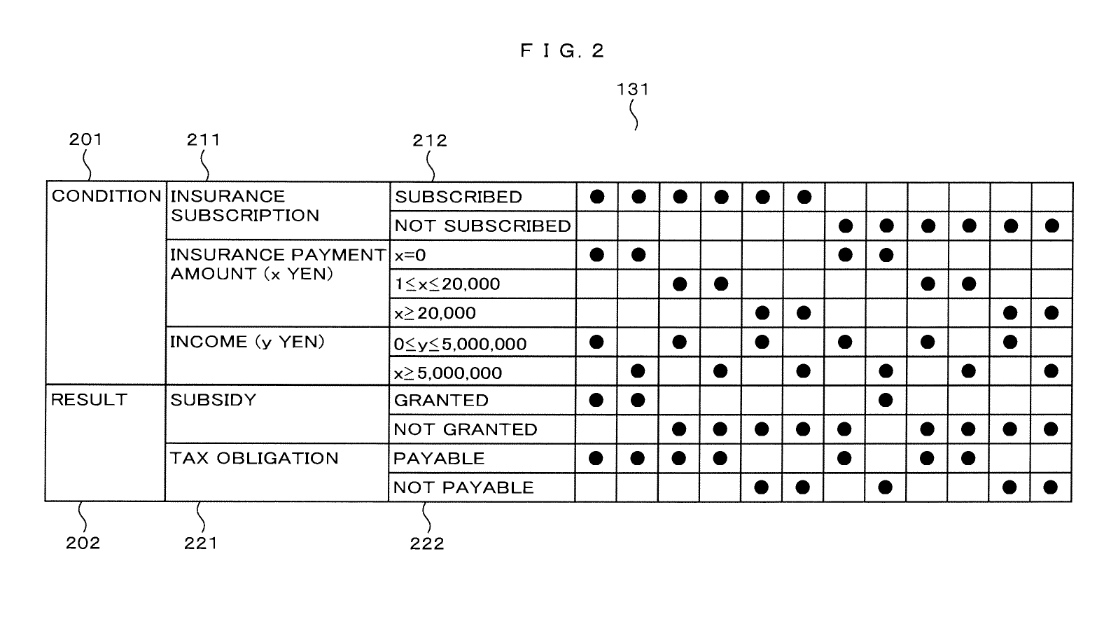

FIG. 2 is a view of an example of the software specification 131 according to the first embodiment. Here, as the software specification 131, an example of the specification described in the form of a decision table that is disclosed in Japanese Unexamined Patent Application Publication No. 2012-190203.

The software specification 131 (decision table) defines the relationship between the condition before the execution of the software and the result after the execution of the software, in the form of the table. The software specification 131 includes a condition definition part 201 and a result definition part 202. The condition definition part 201 includes one or multiple condition factors 211. Further, each condition factor includes two or more condition values 212. Similarly, the result definition part 202 includes one or multiple result factors 221. Further, each result factor includes two or more values of the result value 222.

In each column of the table, a mark is allocated for each condition/result factor. Each column shows the input-output relationship between what value the condition value (input value) takes and what result value (output value) the result factor has according to the marked locations. For example, the leftmost column in FIG. 2 shows that if “INSURANCE SUBSCRIPTION” is “SUBSCRIBED”, “INSURANCE PAYMENT AMOUNT” is “0 YEN”, and “INCOME” is “BETWEEN 0 AND LESS THAN 5 MILLION YEN”, “SUBSIDY” is “GRANTED” and “TAX OBLIGATION” is “PAYABLE”.

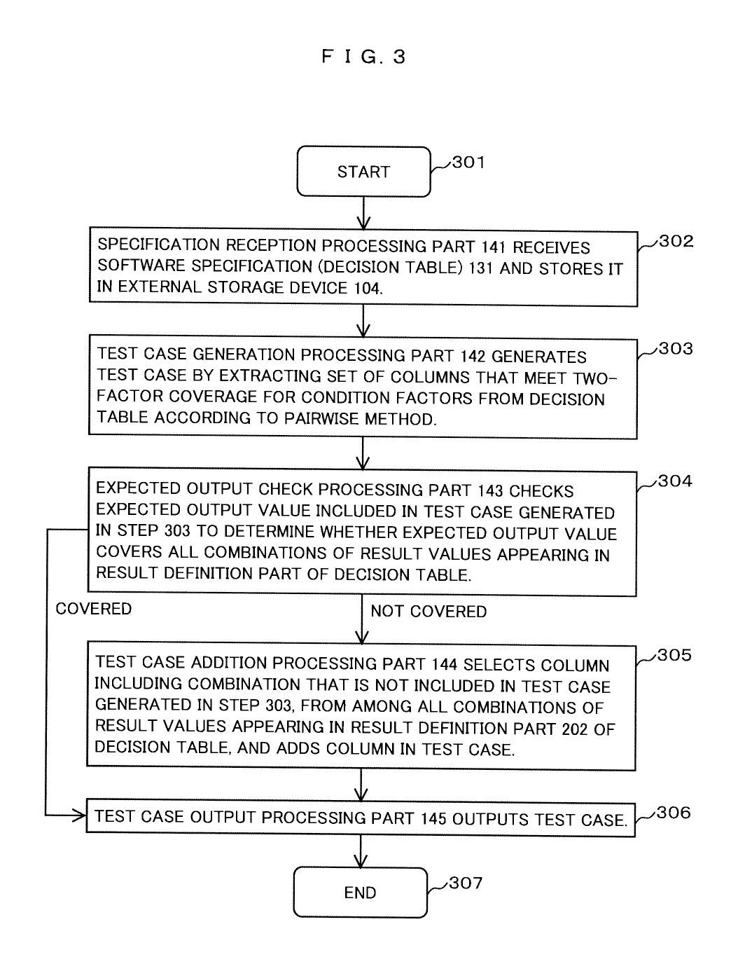

FIG. 3 is a flow chart showing the outline of the process for generating a test case from the software specification according to the first embodiment.

Step 301: Start.

Step 302: The specification reception processing part 141 receives the decision table which is the software specification 131 through the input device 107, or from the storage medium 105 through the reader 106, or through the communication device 109. Then, the specification reception processing part 141 stores the software specification 131 (decision table) in the external storage device 104.

Step 303: The test case generation processing part 142 generates, according to the pairwise method, a test case (in which the condition definition part 201 of each column corresponds to the test input value, and the result definition part 202 of each column corresponds to the expected output value) by extracting a set of columns that meet two-factor coverage with respect to the condition factors, from the software specification (decision table) 131 stored in the external storage device 104. Then, the test case generation processing part 142 stores the generated test case in the external storage device 104. In the process of Step 303, at least one test case is generated including the test input value and the expected output value that meet the software specification 131, from the software specification 131.

Here, the pairwise method in step 303 is the method for selecting pairs of values that cover all combinations of two factors (which is called two-factor coverage), when each of multiple factors takes one of several values. The specific method is disclosed, for example, in the related literature described above.

For example, in the case of the software specification (decision table) 131 shown in FIG. 2, the condition factor includes the following three factors: “INSURANCE SUBSCRIPTION”, “INSURANCE PAYMENT AMOUNT”, and “INCOME”. For example, the “INSURANCE SUBSCRIPTION” and the “INSURANCE PAYMENT AMOUNT” are taken as a pair of two factors from the group of three. In this case, the number of pairs of values that the two factors can take is 6: “SUBSCRIBED, 0 YEN”, “SUBSCRIBED, BETWEEN 0 AND LESS THAN 20,000 YEN”, “SUBSCRIBED, 20,000 YEN OR MORE”, “NOT SUBSCRIBED, 0 YEN”, “NOT SUBSCRIBED, BETWEEN 0 AND LESS THAN 20,000 YEN”, and “NOT SUBSCRIBED, 20,000 YEN OR MORE”. Similarly, the number of pairs of values that the two factors of “INSURANCE FEE” and “INCOME” can take is 6. Further, the number of pairs of values that the two factors of “INSURANCE SUBSCRIPTION” and “INCOME” can take is 4. In the pairwise method, pairs of values of all the factors are selected so as to include all these combinations.

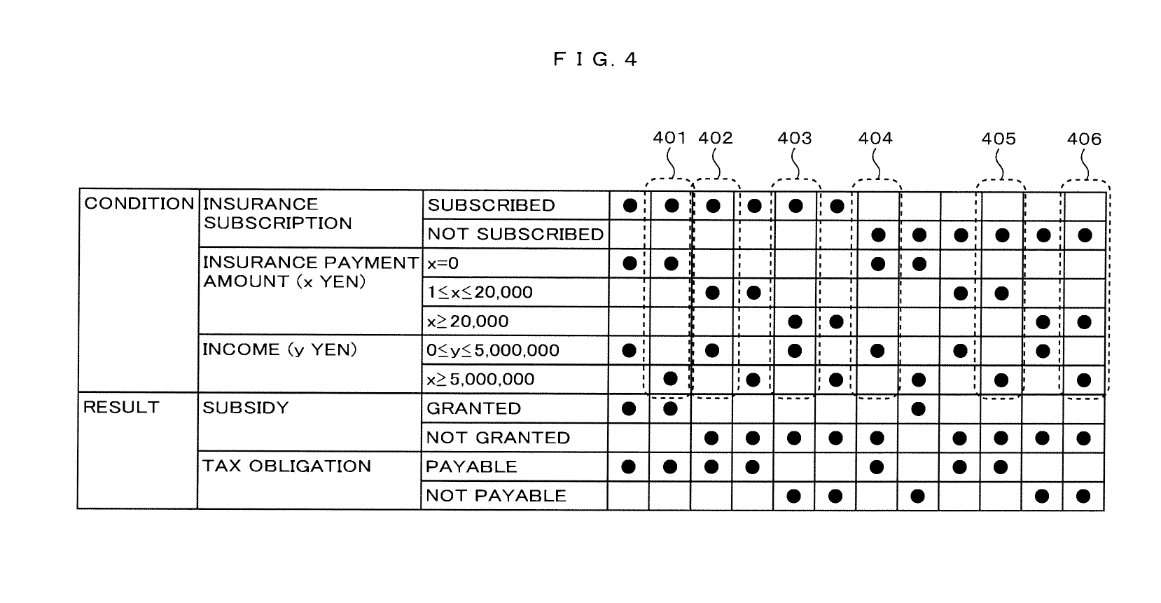

FIG. 4 shows an example of pairs of values that cover all combinations of two factors that are selected by the pairwise method. If six columns (401 to 406) surrounded by dashed lines in FIG. 4 are selected, it is possible to check that they actually provide two-factor coverage. In this case, all software defects caused by two or less condition factors can be detected.

In the known pairwise method describe above, in step 303, it is to be noted that only the condition factors are referred to but the result factors are not referred to in the test case generation. In other words, although the input value included in the test case is selected to guarantee certain coverage such as two-factor coverage, such coverage may not be guaranteed with respect to the expected output value. Thus, as shown in the next step 304, the expected output check program 123 checks if the test case covers the expected output value. If there is a lack of test case, the test case addition program 124 adds the test case as shown in step 305, in order to achieve two-factor coverage with respect to the condition factors. In addition, it is possible to generate a test case that covers all possible values that can be output in the software specification.

Step 304: The expected output check processing part 143 checks the expected output value included in the test case generated in step 303. Then, the expected output check processing part 143 checks whether the test case covers all combinations of result values that appear in the result definition part 202 of the software specification (definition table) 131. If the test case does not cover all combinations of result values, the process proceeds to step 305. Otherwise, the process proceeds to step 306.

Step 305: The test case addition processing part 144 selects a column (test case) that includes the combination that is not included in the test case generated in step 303, from all combinations of result values appearing in the result definition part 202 of the software specification (decision table). Then, the test case addition processing part 144 adds the selected column (test case) to the test case stored in the external storage device 104.

Step 306: The test case output processing part 145 outputs the obtained test case to the display device 108 or an output device such as a printer not shown.

Step 307: End.

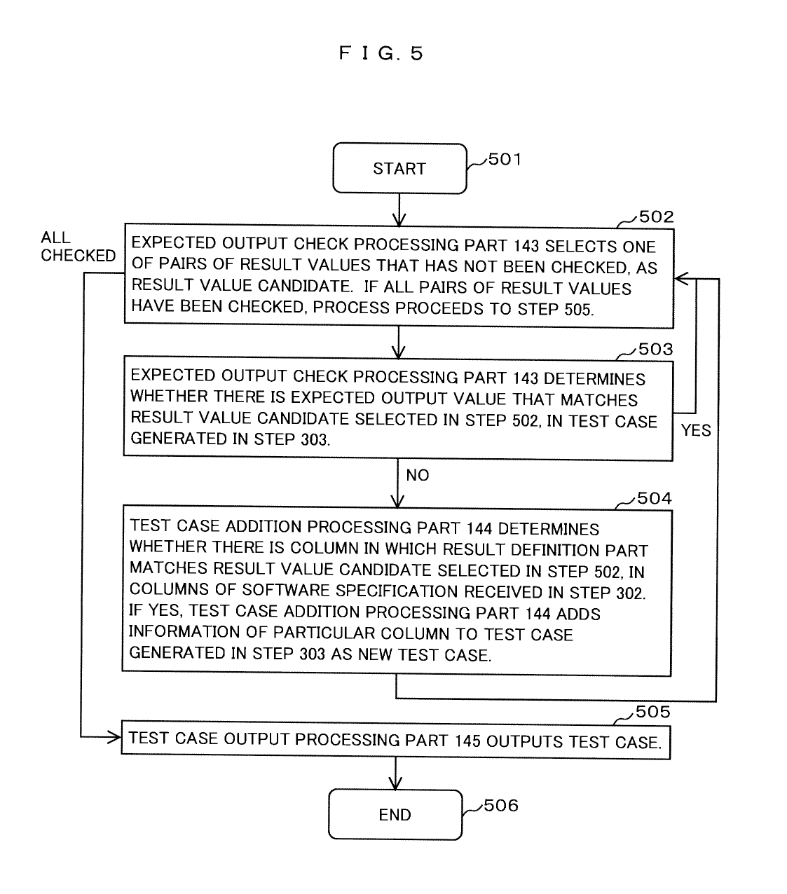

FIG. 5 is a flow chart showing the details of the expected output check process (step 304 in FIG. 3) and the test case addition process (step 305 in FIG. 3).

Step 501: Start.

Step 502: The expected output check processing part 143 selects one unchecked pair from the pairs of values of the result value 222 (one value of the result value 222 is selected for each factor of the result factor 221) in the software specification (decision table) 131, as the result value candidate. If all pairs of the result values (result value candidates) have been checked, the process proceeds to step 505. In other words, the result output check program 123 sequentially checks all possible combinations (result value candidates) for the result value 222. In the example of the software specification 131 shown in FIG. 2, the result output check program 123 sequentially checks the following four result candidates: 1. “GRANTED” “PAYABLE”, 2. “GRANTED” “NOT PAYABLE”, 3. “NOT GRANTED” “PAYABLE”, and 4. “NOT GRANTED” “NOT PAYABLE”.

Step 503: The expected output check processing part 143 checks if there is an expected output value that matches the result value candidate selected in step 502, in the test case generated in step 303. If yes, the process returns to step 502.

Step 504: The test case addition processing part 144 checks if there a column in which the result definition part 202 matches the result value candidate selected in step 502, in the columns of the software specification (decision table) 131 received in step 302. In other words, the test case addition processing part 144 checks if the result value candidate selected in step 502 can be generated as the process result defined by the software specification 131. If it is determined that there is a column in which the result definition part 202 matches the result value candidate selected in step 502, in the columns of the software specification (decision table) 131 received in step 302, namely, if it is determined that the result value candidate selected in step 502 can be generated as the process result defined by the software specification 131, the test case addition processing part 144 adds the information of the particular column, as a new test case, to the test case generated in step 303 and returns to step 502. Otherwise, it just returns to step 502.

As described above, the process shown in steps 502 to 504 determines one out of the following three, by sequentially changing the result value candidates: whether the particular result value candidate is (1) included in the test case that has been output, (2) not included in the test case and originally may not be output in the software specification, or (3) not included in the test case but can be output in the software specification. If it is determined as (3), the particular result value candidate is added as the test case to be added to guarantee that the obtained test cases cover the expected output values.

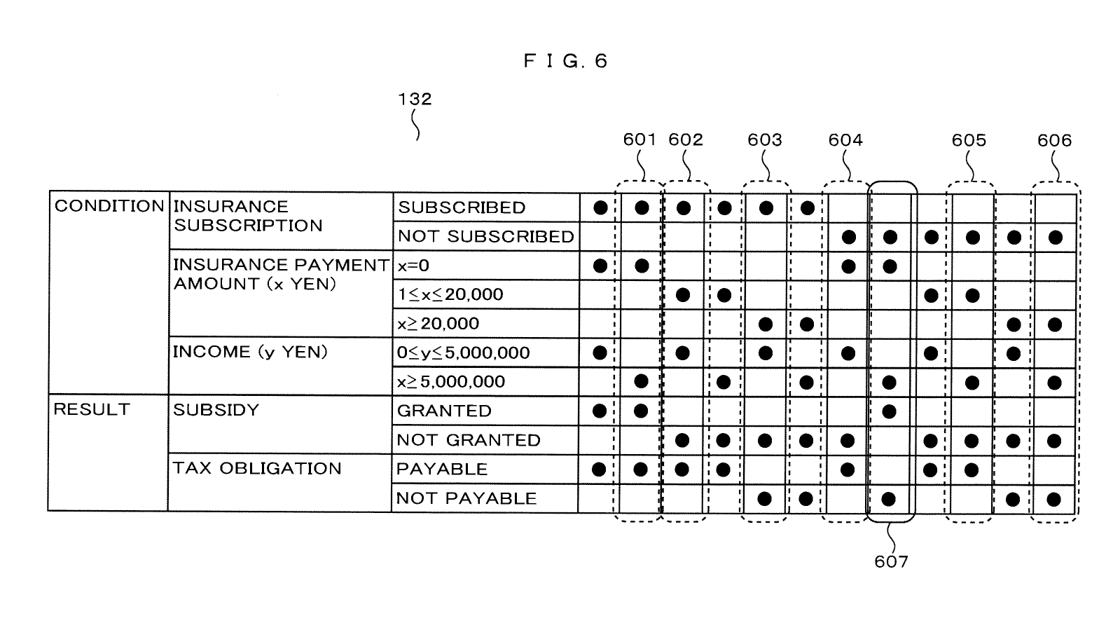

FIG. 6 is a view of an example of the test cases generated according to the process shown in FIGS. 3 and 5. The six columns (601 to 606) surrounded by dashed lines are the test cases generated by the process shown in step 303 in FIG. 3. One column (607) surrounded by a solid line is the test case that is added according to the process shown in steps 304 to 305 in FIG. 3, and more specifically, the process shown in steps 502 to 504 in FIG. 5. The seven test cases in total can achieve two-factor coverage with respect to the condition factors, while covering all possible values that can be output in the specification.

Step 505: Similarly to step 306, the test case output processing part 145 outputs the obtained test case to the display device 108 or an output device such as a printer not shown.

Step 506: End.

As described above, according to the first embodiment, it is possible to generate a test case that guarantees coverage of expected output values, from the software specification (decision table) 131.

### Second Embodiment

According to the method shown in the first embodiment, it is possible to generate a test case that guarantees coverage of expected output values from the software specification given as the software specification (decision table) 131.

The size of the software specification (decision table) 131 increases as the number of condition factors and condition values increases. Thus, the main storage device 103 may have a large storage capacity to process a large number of condition factors and condition values of the software specification 131. On the other hand, Japanese Unexamined Patent Application Publication No. 2012-190203 discloses a method for generating a decision table by providing a specification in propositional form (hereinafter referred to as a propositional specification). The propositional specification shows the rule in the form of “if (the condition part) is this, then (the result part) is that”, such as “if INSURANCE SUBSCRIPTION is SUBSCRIBED and INSURANCE PAYMENT AMOUNT is 20,000 YEN OR MORE, then SUBSIDY is GRANTED and TAX OBLIGATION is PAYABLE”. According to the method disclosed in Japanese Unexamined Patent Application Publication No. 2012-190203, it is possible to generate a decision table by a set of such rules. In other words, it is possible to hold the software specification as data expressing a set of rules instead of being deployed in the form of the table. One rule may define multiple columns in the software specification, so that it is possible to manage the decision table by the main storage device 103 and the external storage device 104 with a smaller size than that of the case of deploying and storing the software specification in the table.

The second embodiment is basically the same as the first embodiment. However, the software specification is stored as the propositional specification instead of as data deployed in the table. As described above, when the decision table managed as the propositional specification is used as the software specification, it is possible to generate a test case that guarantees coverage of expected output values. At this time, the test case can guarantee coverage of expected output values without the data once deployed in the table, which is preferable from the viewpoint that the storage capacity of the main storage device 103 necessary for processing can be reduced.

In the propositional specification, the rule is described as a propositional logic formula of a propositional variable. The condition part of each rule can be described as a propositional logic formula as follows. First, propositional variables are assigned as A1, A2, . . . and An for each of the values that condition factor A can take. The propositional logic formula of A1 [symbol] [symbol] A2 [symbol] . . . [symbol] [symbol] An (where “ [symbol] ” is the logical product and “ [symbol] ” is the negation) is assigned to the description “the condition factor A is A1”. If multiple conditions are combined with “and” such as “the condition factor A is A1 and the condition factor B is B2”, the propositional logic formulas corresponding to each of the conditions are combined with “ [symbol] ” and assigned to the condition part. Similarly, the propositional logic formula can be assigned to the result part. The propositional specification can be expressed as a pair of propositional logic formulas corresponding to each of the condition part and the result part.

The decision table defined by a set of propositional specifications can be generated as follows. Truth-value assignment will be considered for the marked locations of the condition part with respect to each column of the decision table, as follows. If the k-th value is marked for the condition factor X, the truth-value is assigned as follows: Xk=True, Xi=False (i≠k). At this time, the result value of the particular column is defined as follows: (1) Collect all propositional specifications with which the condition part is satisfied by the truth-value assignment. (2) Generate a propositional logic formula by combining propositional logic formulas corresponding to the result part of the collected propositional specifications, with “ [symbol] ”. Then, combine the clause satisfied when just one of the propositional variables corresponding to the result values for each result factor is true and others are false, with “ [symbol] ”. (3) Search for the truth-value assignment that satisfies the propositional logic formula generated in (2). This can be found by a SAT solver. If just one such a truth-value assignment is found, the combination of result values corresponding to the truth-value assignment is the result value of the particular column. Note that if the truth-value assignment does not exist, there may be inconsistency between the propositional specifications. Further, if two or more truth-value assignments exist, the result is not uniquely determined. In other words, this means that there is an ambiguity in the specifications.

Each process flow in the second embodiment is basically the same as in the first embodiment. However, the expected output check process and the test case addition process shown in FIG. 5 are partially changed.

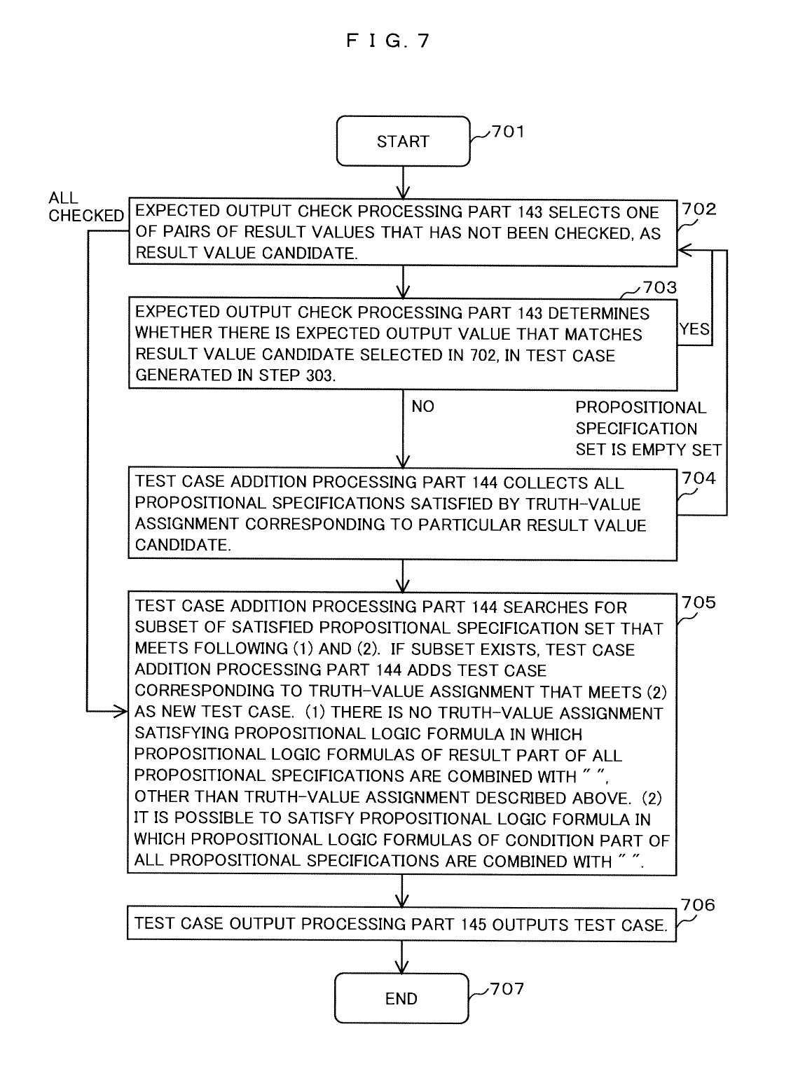

FIG. 7 is a flow chart showing the details of the expected output check process and the test case addition process according to the second embodiment.

Step 701: Start.

Step 702: Similar to step 502. The expected output check processing part 143 selects unchecked one pair from the pairs of values of the result value 222 (one value of the result value 222 is selected for each factor of the result factor 221) in the software specification (decision table) 131, as the result value candidate. If all pairs of result values have been checked, the process proceeds to step 705.

Step 703: Similar to step 503. The expected output check processing part 143 checks if there is an expected output value that matches the result value candidate selected in step 702, in the test case generated in step 303. If yes, the process returns to step 702.

Step 704: The test case addition processing part 144 checks if the result value candidate selected in step 702 can be output in the software specification (propositional specification) received in step 302, as shown below. The test case addition processing part 144 collects all the propositional specifications that are satisfied by the truth-value assignment corresponding to the particular result value candidate. Hereinafter, this set will be referred to as the satisfied propositional specification set. If the satisfied propositional specification set is the empty set, the particular result value may not be output. Thus, the process returns to step 702.

Step 705: The test case addition processing part 144 searches for a subset of the satisfied propositional specification set that meets the following conditions. (1) When a propositional logic formula is generated such that the propositional logic formulas of the result part of all the propositional specifications included in the particular subset are combined with “ [symbol] ”, there is no truth-value assignment satisfying the propositional logic formula, other than the truth-value assignment corresponding to the particular result value candidate described above. (2) It is possible to satisfy the propositional logic formula in which the propositional logic formulas of the condition part of all the propositional specifications included in the particular subset are combined with “ [symbol] ”. If such a subset exists, the test case addition processing part 144 adds the test case with the condition value corresponding to the truth-value assignment satisfying (2) at this time as the test input value, and with the result value candidate selected in step 702 as the expected output value, to the test case generated in step 303 as a new test case. Then, the process returns to step 702. Otherwise, it just returns to step 702.

Step 706: Similar to step 306. The test case output processing part 145 outputs the obtained test case to the display device 108 and an output device such as a printer not shown.

Step 707: End.

Also in the process flow shown in FIG. 7, similarly to the process flow shown in FIG. 5, it is determined whether the particular result value candidate is: (1) included in the test case that has been output; (2) not included in the test case and originally may not be output in the specification; or (3) not included in the test case and can be output in the specification, by changing the result value candidates sequentially. If (3), the particular result value candidate is added as the test case to be added, so as to guarantee that the obtained test case covers expected output values.

According to the second embodiment described above, it is possible to generate a test case that guarantees coverage of expected output values, without deploying data from the software specification given as the propositional specification in the table.

### Another Embodiment

In the first embodiment, the software specification (decision table) 131 may also be expressed by a method different from the method shown in FIG. 2. The first embodiment is not limited to a particular notation, and can be applied to software specifications expressed in other notations. Further, in order to store information given in these notations in the external storage device 104, the data is encoded by an appropriate encoding method. For example, it is possible to use XML or CSV (comma-delimited) format as the encoding method.

Further, in the first embodiment, in step 303 shown in FIG. 3, a test case is assumed to be generated by extracting a set of columns that can provide two-factor coverage for the condition factors, from the software specification (decision table) 131. More commonly, it is also possible to generate a test case by extracting a set of columns to cover all combinations of n factors (this is referred to as n-factor coverage, where n is 2 or more and equal to or less than the total number of factors). In this case, all software defects caused by n or less condition factors can be detected, so that the greater the number n, the better in terms of the test case quality. On the other hand, the smaller the number n, the better in terms of the test execution time because the number of test cases is reduced. Further, the orthogonal representation is also known as a method for achieving a high coverage rate for three or more factors while providing two-factor coverage. The first embodiment is not limited to the pairwise method for providing two-factor coverage, and can also be applied to test cases generated by other test case extraction methods such as the pairwise method for providing n-factor coverage and the orthogonal representation method.

Further, the expected output check process and the test case addition process can be realized by a process flow different from the process flow shown in FIG. 5 such as a process of first generating a list of values that can be output in the software specification and then processing by sequentially changing the result candidate values in the range of the particular list. In this case, there is no need to determine the case (2) whether the particular result candidate value is not included in the test case and originally may not be output in the software specification. It is only necessary to determine whether the particular result candidate value is included in the test case that has been output. Thus, the complexity of the determination process can be reduced.

Further, the first embodiment has been described for the case of generating a test case that covers all possible values that can be output in the software specification. However, the first embodiment can be applied similarly if the coverage condition is changed. For example, it is also possible to first select the result value candidate that can provide two-factor coverage by applying the pairwise method to the result factor, and then apply the process flow described above to the result value candidate. In this case, the obtained test case does not necessarily cover all possible values that can be output in the specification. However, it is possible to obtain a smaller number of test cases than the case of covering all possible values that can be output in the specification, while avoiding excessive deviation of the expected output values included in the obtained test cases. Thus, this is preferable in terms of the test execution time.

What is claimed is:

1. A test case generation method in a test case generation device for generating a test case from software specification,
wherein the test case generation device performs the steps of:
receiving the software specification and storing it in a storage part;
generating a test case including a test input value for particular software from the software specification, as well as an expected output value expected to be obtained as an output value when the software is executed by inputting the test input value, and storing the generated test case in the storage part;
checking whether a value that can be output in the software specification is included in the expected output value; and
as a result of the check, when it is determined that the value that can be output in the software specification is not included in the expected output value, generating a test case including the value that can be output in the software specification as well as a corresponding test input value, and adding the generated test case to the test case stored in the storage part.

2. The test case generation method according to claim 1,
wherein the software specification is a decision table in which the relationship between a condition before the execution of the software and a result after the execution of the software is defined in the form of a table.

3. The test case generation method according to claim 2,
wherein the step performed by the test case generation device to check whether the value that can be output in the software specification is included in the expected output value is a process for checking whether a result value candidate is included in the test case that has been generated and whether the result value candidate can be generated as a process result defined in the decision table, for each result value candidate defined as a combination of result factors of the decision table.

4. The test case generation method according to claim 3,
wherein, as a result of the check for each result value candidate defined as a combination of result factors of the decision table, if the result value candidate is not included in the test case that has been generated and if the particular result value candidate can be generated as the process result defined in the decision table, the test case generation device calculates one input value to provide the result value candidate and adds the input value as a new test case to the test case stored in the storage device.

5. A test case generation device for generating a test case from software specification, the test case generation device comprising:
a specification reception part for receiving the software specification and storing it in a storage part;
a test case generation part for generating a test case including a test input value for particular software from the software specification, as well as an expected output value expected to be obtained as an output value when the software is executed by inputting the test input value, and storing the generated test case in the storage part;
an expected output check part for checking whether a value that can be output in the software specification is included in the expected output value; and
a test case addition part for generating a test case including the value that can be output in the software specification as well as the corresponding test input value if the expected output check part determines that the value that can be output in the software specification is not included in the expected output value, and adding the generated test case to the test case stored in the storage part.

6. The test case generation device according to claim 5,
wherein the software specification is a decision table in which the relationship between a condition before the execution of the software and a result after the execution of the software is defined in the form of a table.

7. The test case generation device according to claim 6,
wherein the expected output check part includes:
a first check part for checking whether a particular result value candidate is included in the test case that has been generated, for each result value candidate defined as a combination of result factors of the decision table; and
a second check part for checking whether a particular result value candidate can be generated as the process result defined in the decision table.

8. The test case generation device according to claim 7,
wherein as a result of the first and second check parts for each result value candidate defined as a combination of result factors of the decision table, if the particular result value candidate is not included in the test case that has been generated, and if the particular result value candidate can be generated as the process result defined in the decision table, the test case addition part calculates one input value to provide the result value candidate and adds as a new test case to the test case stored in the storage part.

9. A storage medium storing a program that can be read by a computer,
wherein the program allows the computer to function as:
a specification receiving unit that receives software specification and stores the software specification in a storage part;
a test case generating unit that generates a test case including a test input value for particular software from the software specification, as well as an expected output value expected to be obtained as an output value when the software is executed by inputting the test input value, and stores the generated test case in the storage part;
an expected output checking unit that checks whether a value that can be output in the software specification is included in the expected output value; and
a test case adding unit that generates a test case including the value that can be output in the software specification as well as a corresponding test input value if the expected output checking unit determines that the value that can be output in the software specification is not included in the expected output value, and adding the generated test case to the test case stored in the storage part.
